(19) United States
(12) Patent Application Publication
(10) Pub. No.: US 2018/0370749 A1
(43) Pub. Date: Dec. 27, 2018

(54) Tape Dispenser and Cutting Unit Thereof

(71) Applicant: SDI CORPORATION, Chang Hua (TW)

(72) Inventors: Yao-Chia Chu, Chang Hua (TW); Cheng Ying Tsai, Chang Hua (TW)

(21) Appl. No.: 15/854,908

(22) Filed: Dec. 27, 2017

(30) Foreign Application Priority Data
Jun. 23, 2017 (TW) 106121140

(51) Int. Cl. B65H 35/00; B65H 16/02; B26F 3/02

(52) U.S. Cl. CPC B65H 35/008; B65H 16/02; B65H 2701/377; B65H 2301/51535; B26F 3/02

(57) ABSTRACT

A tape dispenser includes a base and a cutting unit. The base has a receiving portion at one side thereof. The cutting unit is detachably mounted to the receiving portion and includes a main body and at least one cutting blade. The main body has at least one blade-mounting part and at least one tape-contact part located adjacent to the at least one blade-mounting part. The at least one blade-mounting part has a plurality of supporting portions. The at least one cutting blade is mounted to the at least one blade-mounting part at a specific angle and has a plurality of very thin blade teeth arranged in serration, for labor-saving cutting. The supporting portions contact and correspond to the blade teeth in shape, respectively, for strengthening the structure of the blade teeth. The cutting unit is detachable and replaceable when damaged, deformed, or worn out.

### BACKGROUND OF THE INVENTION

### 1. Field of the Invention

The present invention relates to office stationery, and particularly to a tape dispenser and a cutting unit thereof.

### 2. Description of Related Art

A conventional tape dispenser has an adhesive tape rotatably mounted at a side thereof. The adhesive tape can be manually pulled out for a desired length and then cut off by a blade located at another side of the conventional tape dispenser, thereby obtaining a cut-out tape strip of the desired length for use. Since greater force is usually required to cut off the adhesive tape from the conventional tape dispenser and the thickness of the blade is too large to cause a preferably flat fracture on the cut-out tape strip, some labor-saving structures for improving the conventional tape dispenser have been developed on the market.

TW Patent No. M524839 discloses a labor-saving blade for a tape dispenser. The blade includes a plurality of teeth formed on an upper side thereof in serration. Each of the teeth has an arc-shaped portion inclined downwardly and recessed inwards. Distal ends of the arc-shaped portions of two adjacent said teeth joint each other to be valley-like. Such foregoing design of blade can facilitate the user to cut an adhesive tape smoothly to get a cut-out tape strip with a preferably flat fracture.

Another TW Patent No. M387863 discloses an improved blade structure of a tape dispenser. The blade has a plurality of teeth formed at an upper side thereof and arranged closely. An arc-shaped portion is formed between every two adjacent said teeth. Each of the teeth has a round tip and two blade edges located at two opposite sides of the round tip, respectively. The arc-shaped portions and the round tips jointly constitute arc-shaped cutting edges. When a cutting surface of the adhesive tape transversally abuts against the blade and is pressed downwardly to be cut by the round tip, the adhesive tape is evenly forced and smoothly cut, thus getting a cut-out tape strip having a preferably flat fracture for optimal use.

CN Patent Publication No. 104781054A discloses a conventional tape cutting blade and a tape dispenser. The conventional tape cutting blade has a raised portion, a flat portion, and an abutment portion for increasing the strength and durability of the blade. Fingers are not subject to injury when touching the blade. In addition, the tape cutting blade can be operated with less strength for cutting off a tape strip from a tape.

For the labor-saving purpose, the conventional tape-cutting techniques mostly changed intervals between the teeth of the blade or modified the teeth shape of the blade. However, to maintain the strength of the blade, reduction of blade thickness is barely taken into account. Thus, it still needs greater strength to cut the adhesive tape and the fracture on the cut-out tape strip tends to be not flat.

Besides, the blade and the base of the conventional tape dispenser are undetachably fixed to each other as a single piece, so when the blade is worn out, the entire tape dispenser rather than the blade needs to be replaced.

To overcome the aforesaid shortcomings of the conventional tape dispenser, the present invention provides a tape dispenser and a cutting unit thereof.

### SUMMARY OF THE INVENTION

To solve the problems that the blade thickness of the conventional tape dispenser cannot be reduced and that the blade cannot be replaced independently since the blade and the base are undetachably fixed to each other as a single piece, the present invention provides a tape dispenser with a replaceable and detachable cutting unit. The cutting unit has a supporting portion for strengthening the blade, so the thickness of the blade can be reduced. In this way, the adhesive tape can be cut with a flat fracture, and the blade is laborsaving for cutting the tape and is replaceable when worn out, so the service life of the blade can be prolonged.

The present invention provides a tape dispenser and a cutting unit thereof. The tape dispenser includes a base and the cutting unit. The base has a receiving portion formed at one side thereof. The cutting unit is detachably mounted to the receiving portion and includes a main body and at least one cutting blade. The main body has at least one blade-mounting part and at least one tape-contact part located adjacent to the at least one blade-mounting part. The at least one blade-mounting part has a plurality of supporting portions. The at least one cutting blade is mounted to the at least one blade-mounting part and has a plurality of blade teeth arranged in serration. The supporting portions tightly contact and correspond to the blade teeth in shape, respectively.

The cutting unit is detachable and replaceable when damaged, deformed, or worn out. The thickness of the at least one cutting blade can be reduced significantly to enhance the cutting efficiency.

Preferably, the main body of the cutting unit has two said blade-mounting parts opposite to each other and two said tape-contact parts opposite to each other, and the cutting unit has two said cutting blades.

Preferably, a cutting angle is defined between each said cutting blade and each said tape-contact part, and the cutting angle ranges from 12 degrees to 25 degrees.

Preferably, each of the blade teeth has a tooth thickness ranging from 0.04 mm to 0.06 mm.

Preferably, a cutting height is defined between each said tape-contact part and each of the blade teeth, and the cutting height ranges from 0.3 mm to 2 mm.

Preferably, a strengthening angle is defined between each said supporting portion and each said blade tooth of the cutting blade, and the strengthening angle is an acute angle.

Preferably, the strengthening angle ranges from 20 degrees to 45 degrees.

Preferably, a reserved interval is defined between each said supporting portion and each said blade tooth of the cutting blade, and the reserved interval is positively correlative with the strengthening angle.

Preferably, the reserved interval ranges from 0.05 mm to 0.3 mm.

Preferably, a material that each said cutting blade is made of is different from that of each said supporting portion.

### BRIEF DESCRIPTION OF THE DRAWINGS

FIG. 1 is a perspective view of a tape dispenser in accordance with a preferred embodiment of the present invention;

FIG. 2 is an exploded perspective view of the tape dispenser shown in FIG. 1;

FIG. 3 is a perspective view of a cutting unit of the tape dispenser shown in FIG. 1;

FIG. 3A is an enlarged view of a part of the cutting unit shown in FIG. 3;

FIG. 4 is another perspective view of the cutting unit of the tape dispenser shown in FIG. 3;

FIG. 4A is an enlarged view of a part of the cutting unit shown in FIG. 4;

FIG. 5 is a front view of the cutting unit of the tape dispenser shown in FIG. 3;

FIG. 5A is an enlarged front view of a part of the cutting unit shown in FIG. 5;

FIG. 6 shows a vertical section taken along a line 6-6 shown in FIG. 5;

FIG. 7 shows an enlarged vertical section of a part of the cutting unit shown in FIG. 6;

FIG. 8 is a schematic view of the tape dispenser in operation before a tape roll is installed;

FIG. 9 is another schematic view of the tape dispenser in operation after a tape roll is installed; and

FIG. 10 shows flow charts of replacing the cutting unit of the tape dispenser shown in FIG. 9.

### DETAILED DESCRIPTION OF PREFERRED EMBODIMENT

First of all, directional references, such as “outer”, “inner”, “external”, “internal”, “outward”, “inward”, “downward”, “upward”, “top”, “bottom”, “uppermost”, “lowermost”, and the like, are only used based on conventional orientation of the drawings for identification purposes to facilitate the reader to understand the present invention by reference to the drawings and do not limit the associated elements, particularly as to the position, orientation, or use of this disclosure. Also, a person skilled in the art should notice this description may contain other terminology to convey position, orientation, and direction without departing from the principles of the present invention.

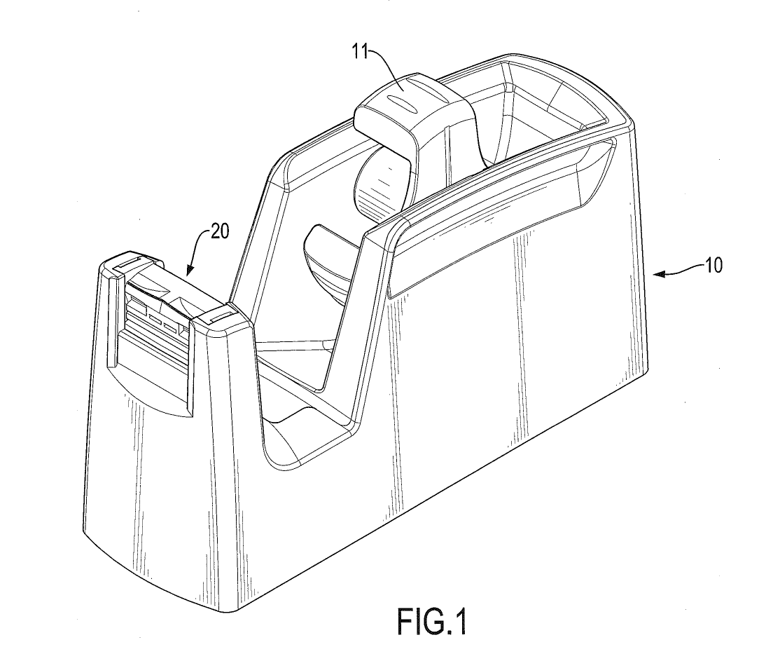

With reference to FIGS. 1 to 4, a tape dispenser constructed in accordance with a preferred embodiment of the present invention includes a base 10 and a cutting unit 20.

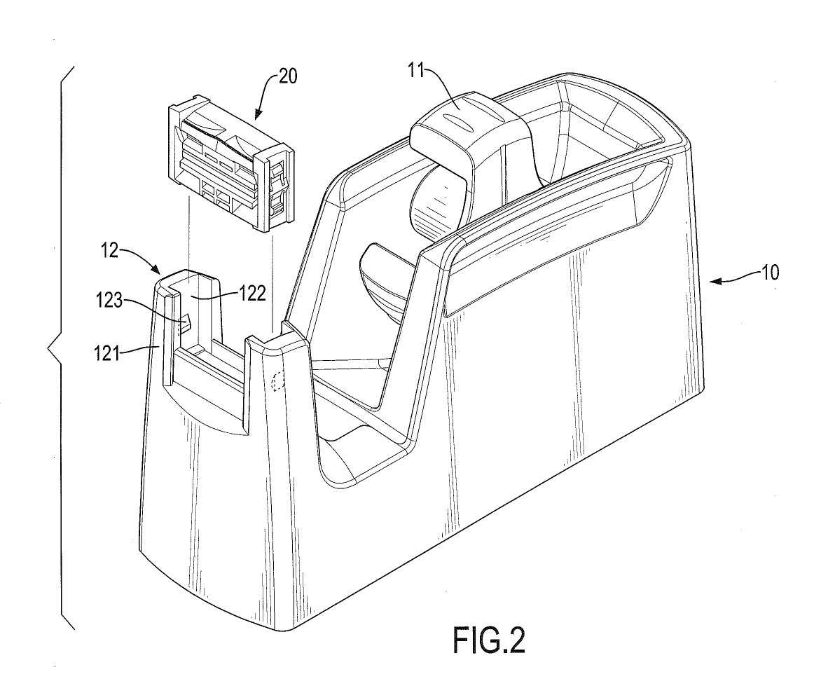

Referring to FIGS. 1 and 2 again, the base 10 includes an assembling portion 11 and a receiving portion 12, which are located at two sides of the base 10, respectively. The receiving portion 12 has two columns 121 and a recess 122 formed between the two columns 121. The columns 121 each have a respective first engaging portion 123. The two first engaging portions 123 are formed on two inner surfaces of the two columns 121, respectively, and face each other. Each of the first engaging portions 123 can be a protrusion or a recession. In the preferred embodiment, each of the first engaging portions 123 is a protrusion.

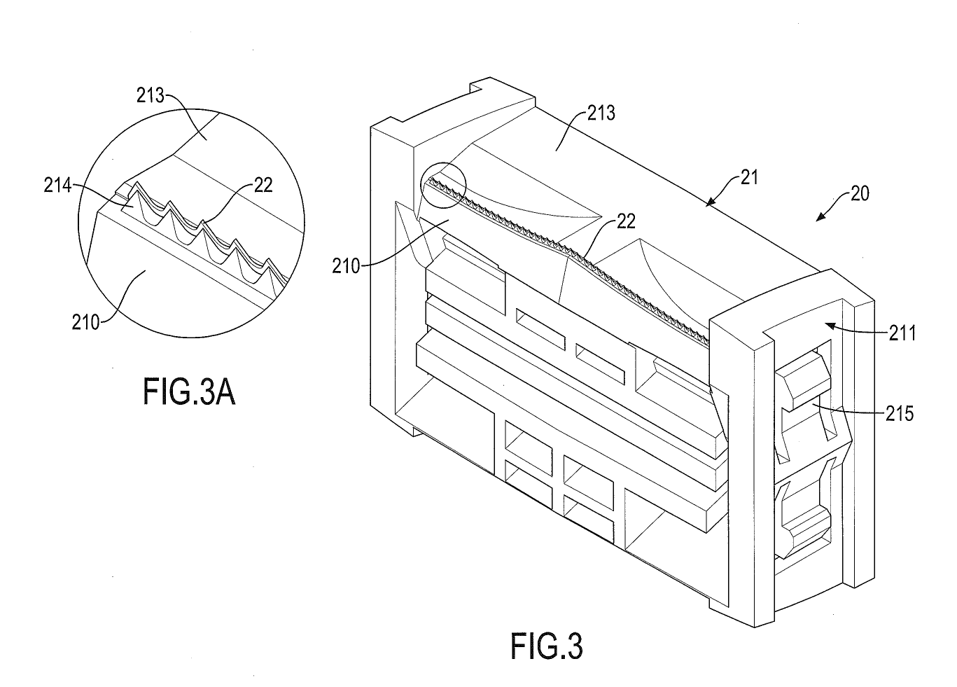

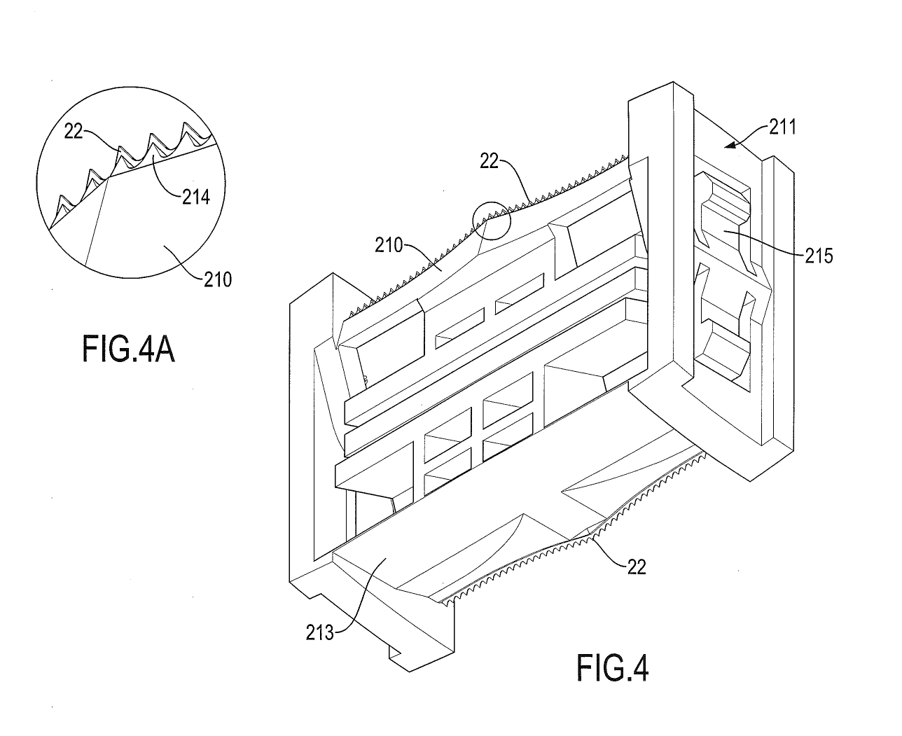

As shown in FIGS. 1 and 2, the cutting unit 20 is detachably mounted to the receiving portion 12 of the base 10. Referring to FIGS. 3 and 4 again, the cutting unit 20 includes a main body 21 and at least one cutting blade 22. The main body 21 includes at least one blade-mounting part 210, at least one second engaging portion 211, and at least one tape-contact part 213. In the preferred embodiment of the present invention, the main body 21 is rectangular and has two said blade-mounting parts 210 opposite to each other, two said second engaging portions 211 opposite to each other, and two said tape-contact parts 213 opposite to each other. The blade-mounting parts 210 are diagonally symmetrically mounted to the main body 21. The cutting blade 22 has two opposite flat sides defined as a first flat side and a second flat side, respectively.

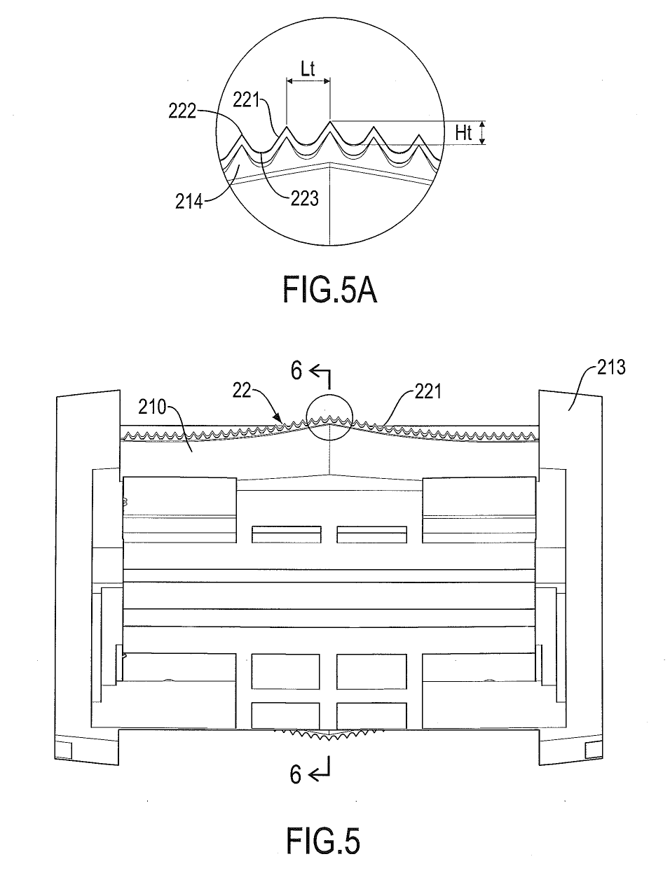

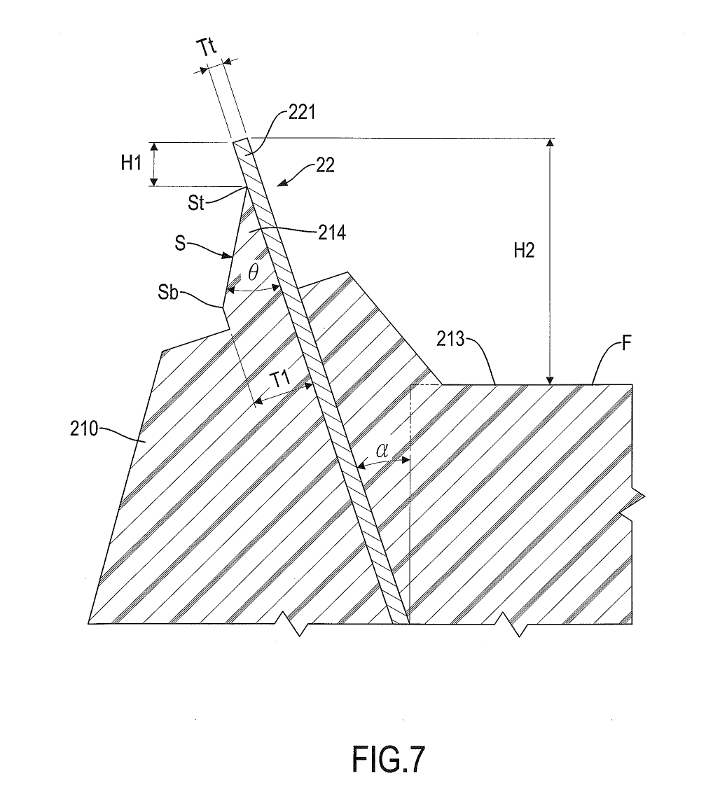

With reference to FIGS. 5 and 7, in the preferred embodiment, the two blade-mounting parts 210 are located at a top left edge and a bottom right edge of the main body 21, respectively. The tape-contact parts 213 are located at a top side and a bottom side of the main body 21, respectively, and are connected with the second engaging portions 211, respectively. The tape-contact parts 213 and the blade-mounting parts 210 are located adjacent to each other. Each of the tape-contact parts 213 has a reference surface F. Each of the blade-mounting parts 210 has a plurality of supporting portions 214 disposed along the first flat side of the cutting blade 22, the first flat side being more adjacent to the supporting portions 214 than the second flat side of the cutting blade 22. The supporting portions 214 are sharp and serrated. The second engaging portions 211 are located at a right side and a left side of the main body 21, respectively, and correspond to the two columns 121 of the receiving portion 12, respectively. Each of the second engaging portions 211 has two claws 215 protruding from the second engaging portion 211 and spaced from each other vertically. The main body 21 is fastened to the receiving portion 12 in such a way that the claws 215 of the second engaging portions 211 are engaged with the two first engaging portions 123, respectively.

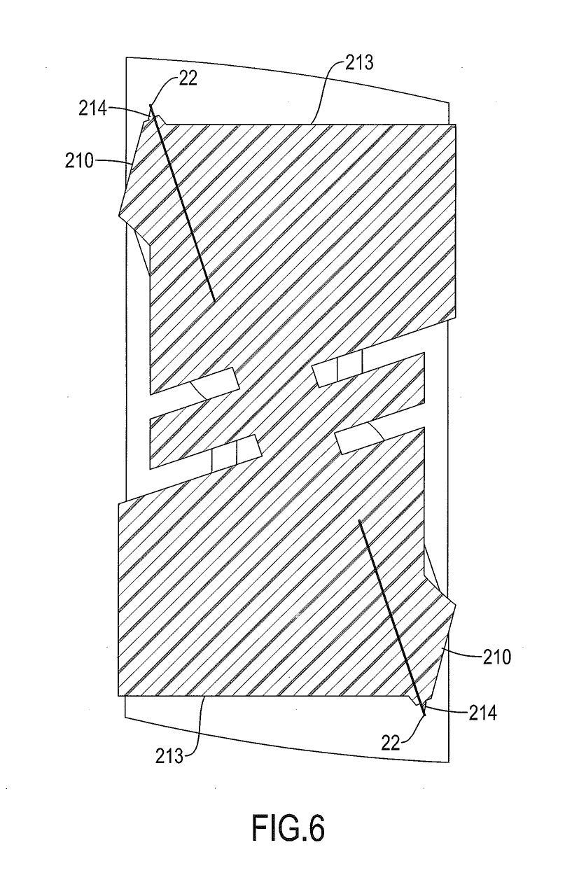

As shown in FIGS. 5, 5A, 6, and 7, the at least one cutting blade 22 is mounted between the at least one blade-mounting part 210 and the at least one tape-contact part 213. Preferably, there are two said cutting blades 22 mounted to the two blade-mounting parts 210, respectively. Each of the cutting blades 22 has a plurality of blade teeth 221. Each of the blade teeth 221 has a tooth tip 222 and a tooth trough 223. A central distance Lt is defined between the tooth tips 222 of two adjacent said blade teeth 221. The central distance Lt ranges from 0.6 mm to 0.7 mm and is set to 0.65 mm as default. A tooth height Ht is defined from the tooth tip 222 to the tooth trough 223 of each of the blade teeth 21. The tooth height Ht ranges from 0.3 mm to 0.4 mm and is set to 0.37 mm as default. A tooth thickness Tt is defined between the two opposite flat sides of each of the blade teeth 221 of each cutting blade 22. The tooth thickness Tt ranges from 0.04 mm to 0.06 mm and is set to 0.05 mm as default.

In the preferred embodiment, each of the supporting portions 214 of the blade-mounting parts 210 corresponds to that of each of the blade teeth 221 of the cutting blades 22 in shape. The supporting portions 214 extend along the orientation of arrangement of the blade teeth 221. Preferably, the blade teeth 221 are arranged in such a way that the blade teeth 221 rise gradually from two opposite ends of the cutting blade 22 toward a midsection of the cutting blade 22, forming a saw-toothed arrangement formed of a relatively higher midsection and two other relatively lower sections of the cutting blade 22.

Referring to FIG. 5 in view of FIG. 7 again, taking one side of the cutting unit 20 as an example for elaboration, the shape of each of the supporting portions 214 corresponds to that of each of the blade teeth 221 of each of the cutting blades 22. Each of the supporting portions 214 is triangular in a longitudinal cross-section view and has an inclined surface S, an uppermost end St, and a lowermost end Sb. The uppermost end St and the lowermost end Sb are located at two opposite ends of the inclined surface S, respectively. A strengthening angle θ is defined between each of the inclined surfaces S of the supporting portions 214 and each of the cutting blades 22. The strengthening angle θ is an acute angle ranging from 20 degrees to 45 degrees. A supporting thickness T1 is a vertical distance defined between the lowermost end Sb of each of the supporting portions 214 and the first flat side of each of the cutting blades 22. The supporting thickness T1 ranges from 0.1 mm to 0.3 mm. A reserved interval H1 is a vertical distance defined between two imaginary horizontal planes where the uppermost end St of each of the supporting portions 214 and the tooth tip 222 of each of the blade teeth 221 are located, respectively. The reserved interval H1 ranges from 0.05 mm to 0.3 mm, preferably ranging from 0.1 mm to 0.2 mm. The reserved interval H1 and the strengthening angle θ have a positive correlation therebetween, i.e. the larger the reserved interval H1, the larger the strengthening angle θ and likewise, the smaller the reserved interval H1, the smaller the strengthening angle θ.

In addition, a material that each of the supporting portions 214 is made of can be the same with or different from that of each said cutting blade 22. In the preferred embodiment, the supporting portions 214 are made of plastic and the cutting blades 22 are made of metal.

With reference to FIGS. 5 and 7 again, a cutting angle α is an included angle defined between the adjacent flat side of each said cutting blade 22 and an imaginary line perpendicular to the reference surface F. The cutting angle α is an acute angle ranging from 12 degrees to 25 degrees, being set to 18.5 degrees as default for increasing the cutting effect. A cutting height H2 is a vertical distance defined between the reference surface F of each said tape-contact part 213 and an imaginary horizontal plane where the tooth tip 222 of each of the blade teeth 221 is located. The cutting height H2 ranges from 0.3 mm to 2 mm. If the cutting height H2 does not fall within the aforesaid range, the adhesive tape may fail to stick to the tape-contact parts 213 or the cutting effect may be adversely affected. Preferably, the cutting angle α is smaller than or equal to the strengthening angle θ, namely α≤θ.

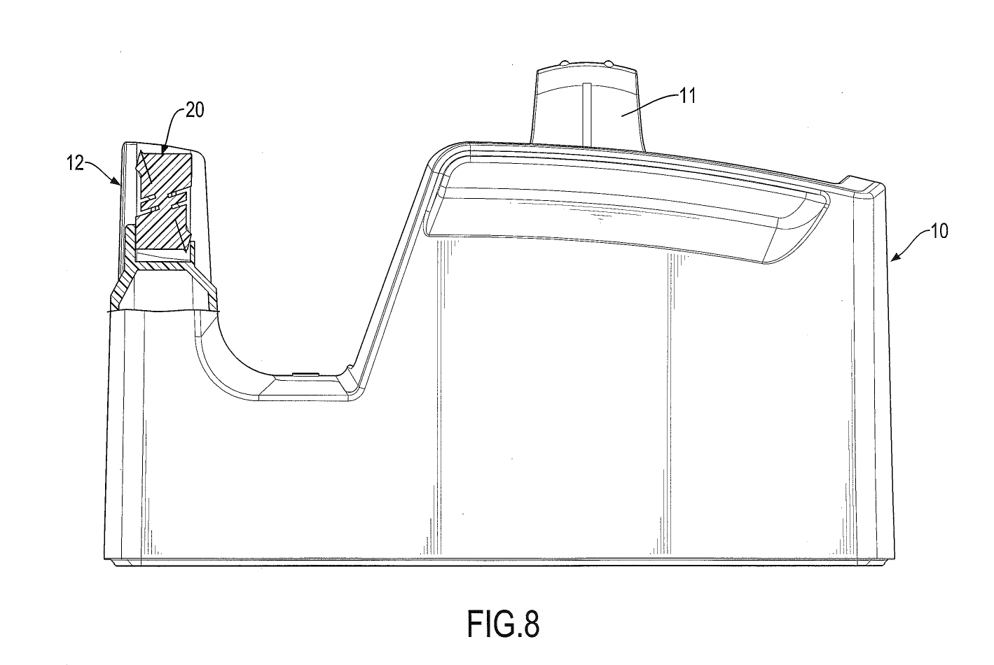

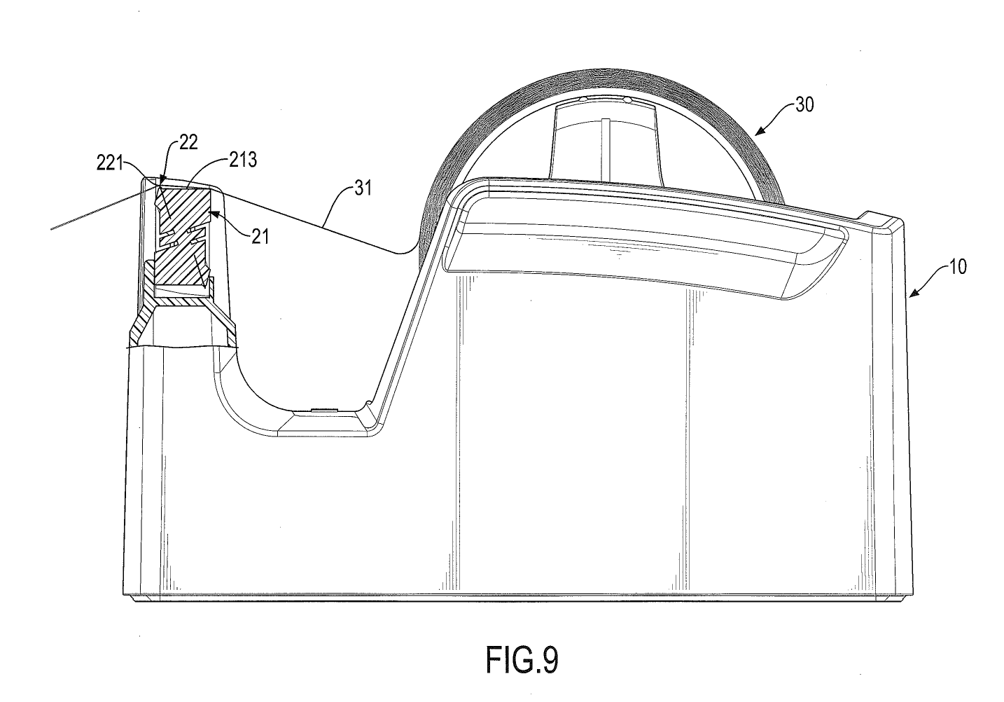

How the preferred embodiment of the present invention is operated is illustrated in FIGS. 8 and 9. The cutting unit 20 is mounted to the receiving portion 12 of the base 10. The second engaging portions 211 of the cutting unit 20 are engaged with the first engaging portions 123 of the base 10, respectively, for fixing the cutting unit 20 securely to the base 10. A tape roll 30 can be installed onto the assembling portion 11 for a user to slightly pull out a tape strip 31 for a desired length from the tape roll 30 and then to make the tape strip 31 pressed against one of the cutting blades 22 of the cutting unit 20 for further cutting off the tape strip 31 from the tape roll 30. Further with reference to FIG. 5 again, because the blade teeth 221 are arranged to be more relatively convex at the midsection of each said cutting blade 20, while the tape strip 31 is being cut downwardly by the cutting blade 20, the tooth tip 222 of the highest blade tooth 221 located at the convex midsection of the cutting blade 22 can first pierce through the tape strip 31. Since the tooth thickness Tt of each said blade tooth 221 is very small as 0.04-0.06 mm to make each said blade tooth 221 sharper than the conventional cutting blades and the cutting angle α makes each said cutting blade 22 inclined relative to each said tape-contact part 213 to lead to a labor-saving angle between the tape strip 31 and the cutting blade 22 when the tape strip 31 is cut by the cutting blade 22, each of the cutting blades 22 is more efficient and labor-saving than the conventional ones in cutting.

Since each of the blade teeth 221 of the cutting blades 22 has the very small tooth thickness Tt, the shape of each of the supporting portions 214 corresponds to that of each of the blade teeth 221 of the cutting blades 22, and the strengthening angle θ is formed between the blade teeth 221 and the supporting portions 214, when the tape strip 31 is being pulled downwardly and cut by the cutting blade 21, the supporting portions 214 can strengthen the structure of the blade teeth 221 externally forced and the tape strip 31 does not easily contact or adhere to the supporting portions 214 to avoid any adverse affect on fluency of the cutting.

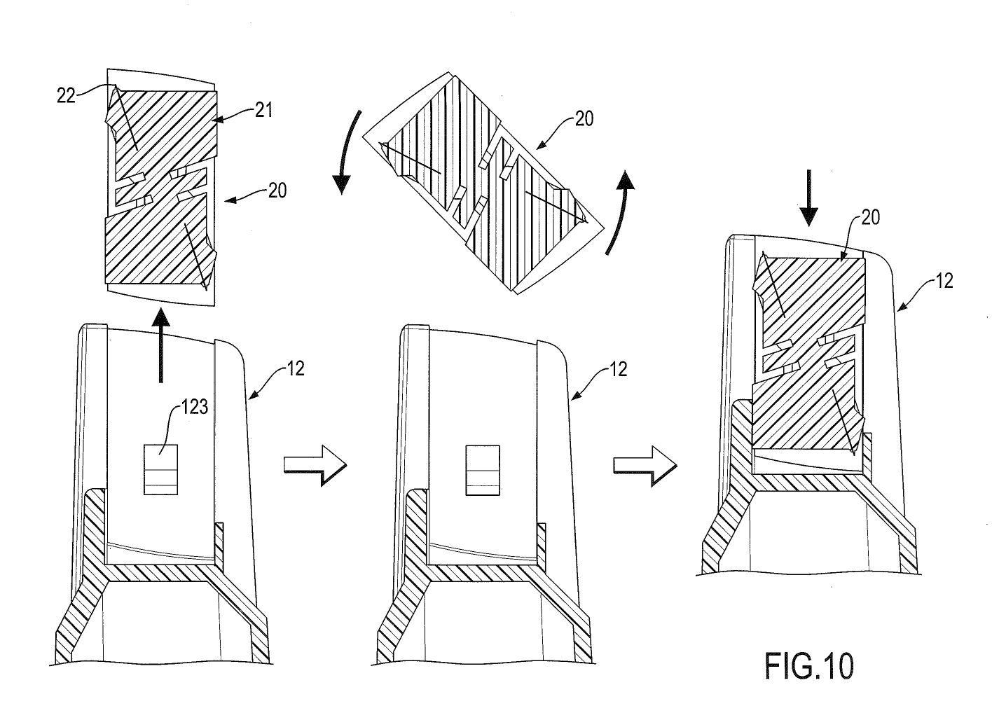

As shown in FIG. 10, if one of the cutting blades 22 of the cutting unit 20 is damaged, deformed, or worn out owing to long-term usage, it can be replaced by the other cutting blade 22 according to the following steps. First, dismount the cutting unit 20 from the receiving portion 12 of the base 10. Second, overturn the cutting unit 20 to make the unused cutting blade 22 of the cutting unit 20 face upwardly and make the unusable cutting blade 22 of the cutting unit 20 face downwardly. Finally, mount the cutting unit 20 into the receiving portion 12 of the base 10 to complete the replacement. Alternatively, the whole cutting unit 20 can be replaced with another usable cutting unit 20. In this way, only the cutting unit 20 rather than the whole tape dispenser needs replacement and the replacement is relatively low-cost, so the service life of the tape dispenser of the present invention is much longer than those of the conventional tape dispensers.

The present invention has advantages as follows:

1. Each said cutting blade of the cutting unit of the present invention has a plurality of blade teeth and a plurality of supporting portions corresponding to the blade teeth in shape, respectively. The supporting portions are capable of supporting and strengthening the structure of the blade teeth. The thickness of the cutting blade can be reduced significantly to make the cutting blade more efficient in cutting. The fracture of the tape strip cut by the cutting blade is also flatter than what are cut by the conventional blades.

2. Contrary to the cutting blades that are either undetachable or fixed to the base of the conventional tape dispenser as one piece, the cutting unit of the present invention is detachable and replaceable. The cutting unit can be installed into the base and has one or a plurality of cutting blades. If either or both of the cutting blades are damaged, deformed, or worn out due to long-term usage, the cutting unit can be overturned to switch the unusable cutting blade to the unused cutting blade for further cutting, or the cutting unit rather than the whole tape dispenser can be replaced with another.

3. Each said cutting blade and each said tape-contact part of the main body have aforesaid specific angle and distance defined therebetween, and each of the blade teeth and each of the supporting portions also have aforesaid specific correlation in angle and distance therebetween, thus improving the efficiency of the cutting unit and making the cutting more labor-saving.

Even though numerous characteristics and advantages of the present invention have been set forth in the foregoing descriptions, together with details of the structure and function of the present invention, the disclosure is illustrative only, and changes may be made in detail, especially in matters of shape, size, and arrangement of parts within the principles of the present invention to the full extent indicated by the broad general meaning of the terms in which the appended claims are expressed.

What is claimed is:

1. A tape dispenser comprising:
a base having
a receiving portion formed at a side of the base; and
a cutting unit detachably mounted to the receiving portion of the base and including
a main body having at least one blade-mounting part and at least one tape-contact part located adjacent to the at least one blade-mounting part, the at least one blade-mounting part having a plurality of supporting portions; and
at least one cutting blade mounted to the at least one blade-mounting part and having a plurality of blade teeth arranged in serration, the supporting portions contacting and corresponding to the blade teeth in shape, respectively.

2. The tape dispenser as claimed in claim 1, wherein a cutting angle is defined between said at least one cutting blade and said at least one tape-contact part, and the cutting angle ranges from 12 degrees to 25 degrees.

3. The tape dispenser as claimed in claim 1, wherein the main body of the cutting unit has two said blade-mounting parts opposite to each other and two said tape-contact parts opposite to each other, and the cutting unit has two said cutting blades.

4. The tape dispenser as claimed in claim 1, wherein each of the blade teeth has a tooth thickness ranging from 0.04 mm to 0.06 mm.

5. The tape dispenser as claimed in claim 1, wherein a cutting height is defined between said at least one tape-contact part and each said blade tooth, and the cutting height ranges from 0.3 mm to 2 mm.

6. The tape dispenser as claimed in claim 1, wherein a strengthening angle is defined between each said supporting portion and each said blade tooth of the at least one cutting blade, and the strengthening angle is an acute angle.

7. The tape dispenser as claimed in claim 6, wherein the strengthening angle ranges from 20 degrees to 45 degrees.

8. The tape dispenser as claimed in claim 6, wherein a reserved interval is defined between each said supporting portion and each said blade tooth, the reserved interval and the strengthening angle having a positive correlation therebetween.

9. The tape dispenser as claimed in claim 8, wherein the reserved interval ranges from 0.05 mm to 0.3 mm.

10. The tape dispenser as claimed in claim 1, wherein a material that each said cutting blade is made of is different from that of each said supporting portion.

11. A cutting unit of a tape dispenser comprising:
a main body having at least one blade-mounting part and at least one tape-contact part located adjacent to the at least one blade-mounting part, the at least one blade-mounting part having a plurality of supporting portions; and
at least one cutting blade mounted to the at least one blade-mounting part and having a plurality of blade teeth arranged in serration, the supporting portions contacting and corresponding to the blade teeth in shape, respectively.

12. The cutting unit as claimed in claim 11, wherein a cutting angle is defined between said at least one cutting blade and said at least one tape-contact part, and the cutting angle ranges from 12 degrees to 25 degrees.

13. The cutting unit as claimed in claim 11, wherein the cutting unit has two said blade-mounting parts opposite to each other and two said tape-contact parts opposite to each other, and the cutting unit has two said cutting blades.

14. The cutting unit as claimed in claim 11, wherein each of the blade teeth has a tooth thickness ranging from 0.04 mm to 0.06 mm.

15. The cutting unit as claimed in claim 11, wherein a cutting height is defined between said at least one tape-contact part and each of the blade teeth, and the cutting height ranges from 0.3 mm to 2 mm.

16. The cutting unit as claimed in claim 11, wherein a strengthening angle is defined between each said supporting portion and each said blade tooth of the at least one cutting blade, and the strengthening angle is an acute angle.

17. The cutting unit as claimed in claim 16, wherein the strengthening angle ranges from 20 degrees to 45 degrees.

18. The cutting unit as claimed in claim 16, wherein a reserved interval is defined between each said supporting portion and each said blade tooth, the reserved interval and the strengthening angle having a positive correlation therebetween.

19. The cutting unit as claimed in claim 18, wherein the reserved interval ranges from 0.05 mm to 0.3 mm.

20. The cutting unit as claimed in claim 11, wherein a material that each said cutting blade is made of is different from that of each said supporting portion.
